(19) United States
(12) Patent Application Publication
(10) Pub. No.: US 2006/0067714 A1
(43) Pub. Date: Mar. 30, 2006

(54) Bit detector having partitioned photo detector

(75) Inventors: Willem Marie Julia Marcel Coene, Eindhoven (NL); Albert Hendrik Jan Immink, Eindhoven (NL); Bernardus Hendrikus Wilhelmus Hendriks, Eindhoven (NL); Aloysius Michael Josephus Maria Spruijt, Eindhoven (NL); Markus Andreas Bernd Werner Bolte, Norderstedt (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/537,880

(22) PCT Filed: Nov. 12, 2003
(86) PCT No.: PCT/IB03/05369

§ 371 Date: Jun. 7, 2005

(30) Foreign Application Priority Data
Dec. 12, 2002 (EP) 02080240.1

(51) Int. Cl. H04B 10/06

(52) U.S. Cl. 398/212

(57) ABSTRACT

The present invention relates to a bit detector for detecting the bit values of bits of a channel data stream stored on a record carrier, wherein the channel data stream comprises a channel strip of at least two bit rows one-dimensionally evolving along a first direction and aligned with each other along a second direction, said two directions constituting a two-dimensional lattice of bit positions. To improve the bit detection performance for 2D storage considerably a bit detector is proposed that comprises:—a photo detector for detecting light reflected from or transmitted through said record carrier in response to one or more incident light beams, each light beam being directed onto a position along said second direction, said photo detector being partitioned into at least two detector partitions for detecting part of the reflected or transmitted light and for generating partial HF signal values, and—a signal processing means for determining the bit values of the bits of said channel data stream from said partial HF signal values.

The present invention relates to a bit detector for detecting the bit values of bits of a channel data stream stored on a record carrier, wherein the channel data stream comprises a channel strip of at least two bit rows one-dimensionally evolving along a first direction and aligned with each other along a second direction, said two directions constituting a two-dimensional lattice of bit positions. Further, the present invention relates to a photo detector, a bit detection method a reproduction device and method and to a computer program for implementing said methods.

In one-dimensional (1D) optical recording, the physical generation of the high-frequent (HF) data-signal is realized through the integration of the (reflected and diffracted) photon distribution over the central aperture (CA). This aperture is the same as the one that is used for the realization of the small focused laser spot that is incident on the information layer of the optical disc. The single analog HF-signal waveform that is the basis for the subsequent bit-detection, is sometimes also referred to as the CA-signal.

Traditional optical recording is based on a 1D spiral along which the physical marks and non-marks that represent the ones and zeroes of the NRZI channel bitstream on the medium evolve in a sequential way along that one dimension. Therefore, the physical diffraction of the laser spot at the pit structures on the medium that gives rise to the physical modulation leading to the HF-signal occurs in the direction along the track or spiral, which is also known as the tangential direction. Radial diffraction, on the other hand, originates from the finite radial extent of the pits and from variations of pit-structures along the radial direction, caused by the fact that successive tracks (that is, successive circumferences of the single spiral) are quite close to each other: the laser spot generates not only signal from the central track, which is the desired component, but also from the neighbouring tracks, a phenomenon better known as cross-talk. Data-detection or bit-detection in 1D optical recording is set-up as a procedure for a single track, independent from the neighbouring tracks: that is, no joint detection in which also the information of the central track that leaks into the signal generated by the spot at the neighbouring track is used, and vice versa, of a set of multiple tracks is aimed at. Therefore, interferences in the signal resulting from the neighbouring tracks can be considered as non-white noise, which has no correlation with the data-signal of the central track.

This means for the case of 1D, that all relevant signals in 1D optical recording, relevant for bit-detection, are generated by tangential diffraction only. This is the very basic reason why any further partitioning of the central aperture in view of possibly improved bit-detection is not that relevant for the 1D-case. As will become clear in the following, the situation for 2D optical recording is quite the opposite.

In 2D optical recording, as it is, for instance, described in non-prepublished European patent application EP 02079097.8 (=PHNL020929), the bits are generally located on a common or coherent, non-deformed 2D lattice, preferably a square lattice or a hexagonal lattice: for each bit considered as a central bit of a cluster of bits, the set of positions of the neighbouring bits relative to the position of the central bit, are always the same. Consequently, the diffraction of the laser spot at these random pit structures occurring at regular well-defined positions of the lattice is always oriented in very well defined directions that are known as the diffraction vectors located on the “reciprocal (space) lattice” corresponding with the “real (space) lattice” of the bits.

Usually, in standard 1D optical recording, the information within the CA is integrated, so that any information about the direction in which diffraction has taken place has been eliminated prior to any bit-detection.

It is an object of the present invention to provide a bit detector and a corresponding bit detection method by which the bit detection performance for 2D storage is considerably improved.

This object is solved according to the present invention by a bit detector as claimed in claim 1 comprising:
a photo detector for detecting light reflected from or transmitted through said record carrier in response to one or more incident light beams, each light beam being directed onto a position along said second direction, said photo detector being partitioned into at least two detector partitions for detecting part of the reflected or transmitted light and for generating partial HF signal values, and
a signal processing means for determining the bit values of the bits of said channel data stream from said partial HF signal values.

A corresponding bit detection method is defined in claim 15

The invention relates also to a photo detector as claimed in claim 16 for use in a bit detector for detecting the bit values of bits of a channel data stream stored on a record carrier, wherein the channel data stream comprises a channel strip of at least two bit rows one-dimensionally evolving along a first direction and aligned with each other along a second direction, said two directions constituting a two-dimensional lattice of bit positions, said photo detector being adapted for detecting light reflected from or transmitted through said record carrier in response to one or more incident light beams, each light beam being directed a position along said second direction, and being partitioned into at least two detector partitions for detecting part of said light and for generating partial HF signal values.

Still further the invention relates to a reproduction device and method and to a computer program for implementing the bit detection method and the reproduction method.

The present invention is based on the idea to partition the photo detector into at least two segments, that are preferably chosen according to the directions in which diffraction takes place in a systematic way. The latter directions, and the amount of diffraction that takes place in each of these directions, can be considered as a kind of fingerprint of the 2D bit cluster to be considered on the channel data stream, i.e. on the 2D lattice of bits according to a preferred embodiment.

The term “photo detector” shall be understood broadly as meaning any device that transforms a light signal into an electrical signal which is used further on as an analog signal waveform. The photo detector receives light that is reflected from or transmitted through the record carrier in response to the incident light beam which is preferably directed onto a particular bit row, but which can also be directed to any position along the second (radial) direction, for instance at more than one bit row, but also in between the bit rows. This also means that there can be more light spots in the array of spots, possibly generated by a diffraction grating, than there are bit-rows in the broad spiral.

For a hexagonal lattice, for instance, a bit cluster may consist of a central bit and six neighbouring bits so that there are 2⁷=64 possible clusters, 32 with a central bit equal to “0”, and thus also 32 with a central bit equal to “1”. These 32 patterns are further distributed as the binomial coefficient

$$( \begin{matrix}6 \\ n\end{matrix} )$$

that is, 1, 6, 15, 20, 15, 6, 1 possible configurations for the respective situations with n=0, 1, 2, . . . , 5, 6 nearest neighbour bits with bit-value “1”.

The advantages of the invention can be explained as follows. A hexagonal bit cluster of seven bits having a central bit equal to “1” and two nearest neighbour bits also equal to “1” shall be considered. The standard HF signal that corresponds with integration over the CA is typical for this type of cluster, but it is also almost identical for all of the 15 possible configurations of the other clusters with 2 nearest neighbours with bit value “1”. So, the azimuth information indicating at which azimuths the nearest neighbour bits with bit-value “1” are located, is erased in the standard way of detection.

According to the invention it is proposed to detect for the given (central) bit a vector of partial HF signals which gives a clue to where the “1”-bit nearest neighbours might be located (along the circle with the 6 possible positions). Each possible configuration of the hexagonal cluster will lead to a set of signals that can be seen as a “fingerprint” for the configuration at hand. The HF signal vector will match some fingerprints much better than others. Further, also at the neighbouring bits, HF signal vectors each comprising a number of partial HF signals, each in their turn match the possible fingerprints with different likelihoods. Each detector partition generates such a partial HF signal value.

Bit detection in this scheme comes down to finding the 2D bit pattern that matches closest to all HF signal vectors detected. Each HF signal vector not only tells something about the central bit value of the cluster, and the number of its neighbours with bit value “1”, but additionally also something about the (most probable) location of the nearest neighbour bits. Another way to look at it is as a large puzzle, where pieces of information at each bit position of the 2D lattice are available: these pieces have to be fitted together as a big jig-saw puzzle.

More practically, bit detection can be represented with a partitioned photo detector as fitting of a binary 2D bitstream to a set of measurements, with one measurement for one bit being represented by a vector of real-valued (or properly quantized) intensity signals. Bit detection can further be performed in a maximum-likelihood sense, where a cost function at a given bit, e.g. defined as a sum of cost functions as in the Euclidian distance, one for each of the signal components in the signal vector, is to represent the likelihood of that bit occurring in the sequence of bits. By minimizing the sum of all cost functions along the sequence it is possible to find the most likely bit sequence. The partitioning is chosen such that it yields additional information about the azimuths of nearest neighbours as described above.

Preferred embodiments of the invention are described in the dependent claims.

Instead of partitioning in the frequency domain, partitioning can also be performed in the image plane so that the pit-structures on the record carrier are directly imaged. In this case an additional lens is provided in the light path between the record carrier and the photo detector. Such detection mode does not suffer from the inversion-symmetry ambiguity that is present when partitioning is applied in the frequency domain.

Generally, the invention is applicable to any kind of two-dimensional code. However, according to preferred embodiments the bits of the channel data stream are arranged on a two-dimensional hexagonal or square lattice.

Preferred embodiments of photo detectors for use with a hexagonal or square lattice code and with partitioning in the frequency domain, are defined in claims 4 to 6. It is advantageous to use an even number of detector partitions and to combine partial HF signals of opposite detector partitions into one partial HF signal. A preferred embodiment provides a six-fold partitioned photo detector resulting in three partial HF signals. However, also other number of detector partitions are usable as well. For instance, in image plane partitioning a detector is advantageous which shows the same partitioning structure as the lattice structure of the code, i.e. in case of a hexagonal lattice code the detector partitions should also be arranged on a hexagonal lattice and each partition should have the same hexagonal structure as the bits of the lattice of the code.

In another preferred embodiment, the detector partitions can also be used to generate push-pull signals by appropriate signal processing means. Therein partial HF signal values generated by detector partitions located on opposite sides of the photo detector are subtracted to obtain said push-pull signals which can then be used for tracking.

Further preferred embodiments using appropriate signal processing means are defined in claims 10 and 11. The partial HF signals obtained by the partitioned photo detector can be used either to detect of which type the bit cluster under consideration is. Depending on the density of the code this is possible for at least some or even all of the bit cluster types. However, it is also possible to evaluate not only the partial HF signal values from only one detection but also from detections of neighbouring bit clusters or bit clusters having overlaps with the present bit cluster. Moreover, the partial HF signals can be used to determine which bit value the bit of the present bit cluster has.

The invention will now be explained in more detail with reference to the drawings in which

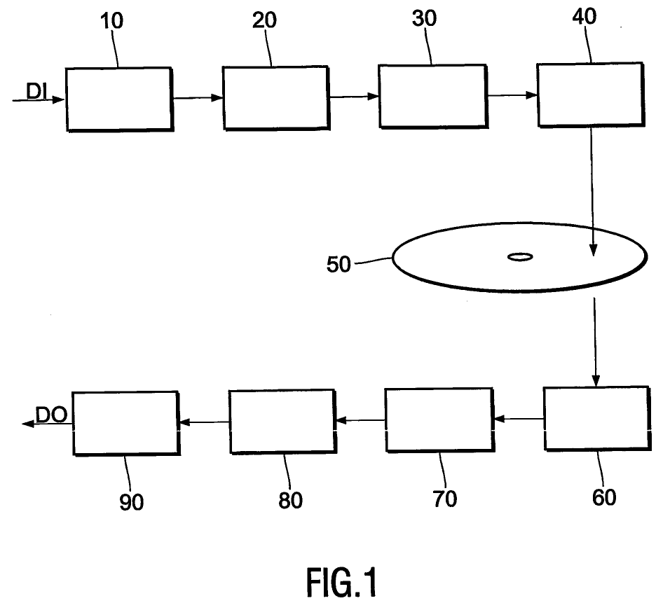

FIG. 1 shows a block diagram of a general layout of a coding system,

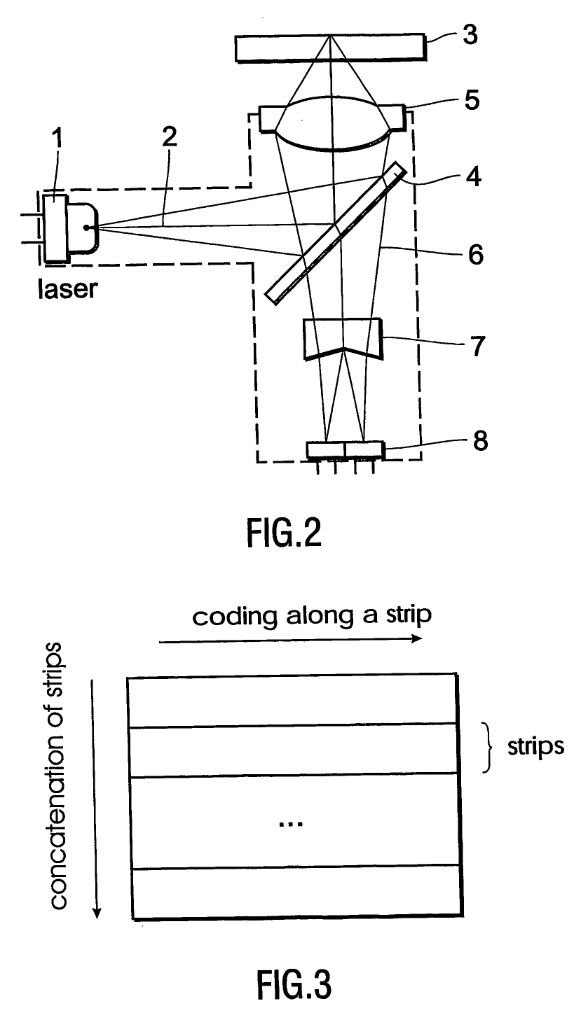

FIG. 2 shows a general set-up of a read-out apparatus according to the present invention,

FIG. 3 shows a schematic diagram indicating a strip-based two-dimensional coding scheme

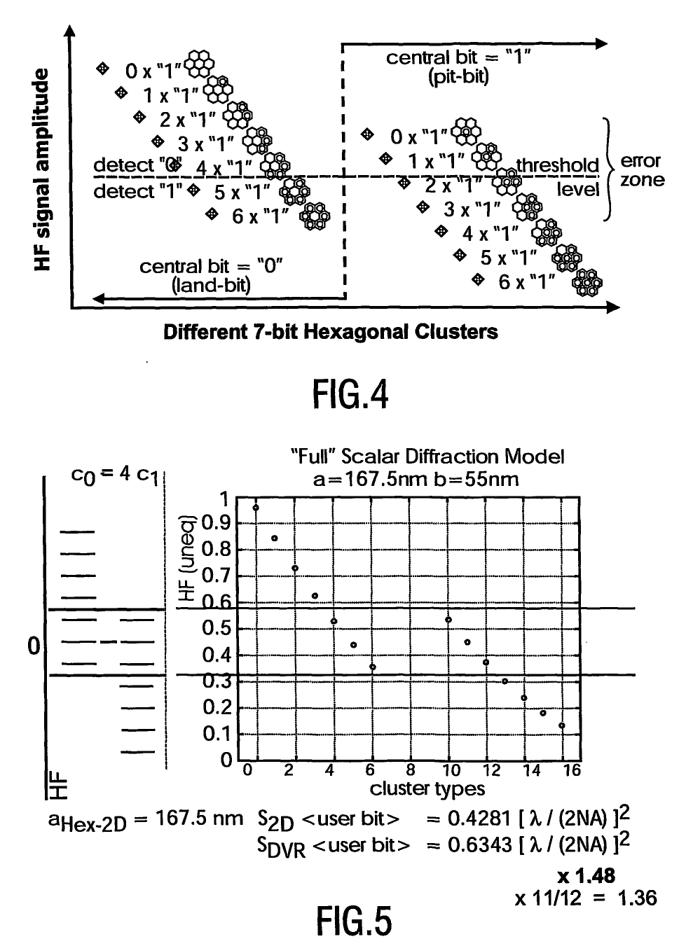

FIG. 4 shows a schematic signal-pattern for a 2D code on hexagonal lattices,

FIG. 5 shows a raw scalar-diffraction signal-pattern for a particular density,

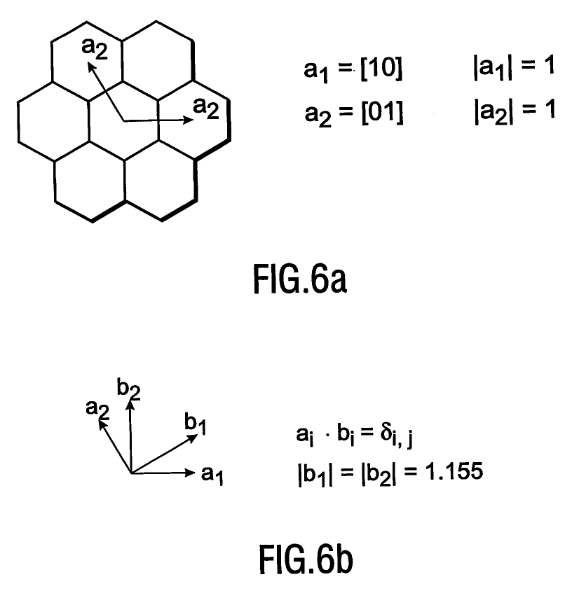

FIG. 6 shows a real-space and a reciprocal-space coordinate system for the hexagonal lattice,

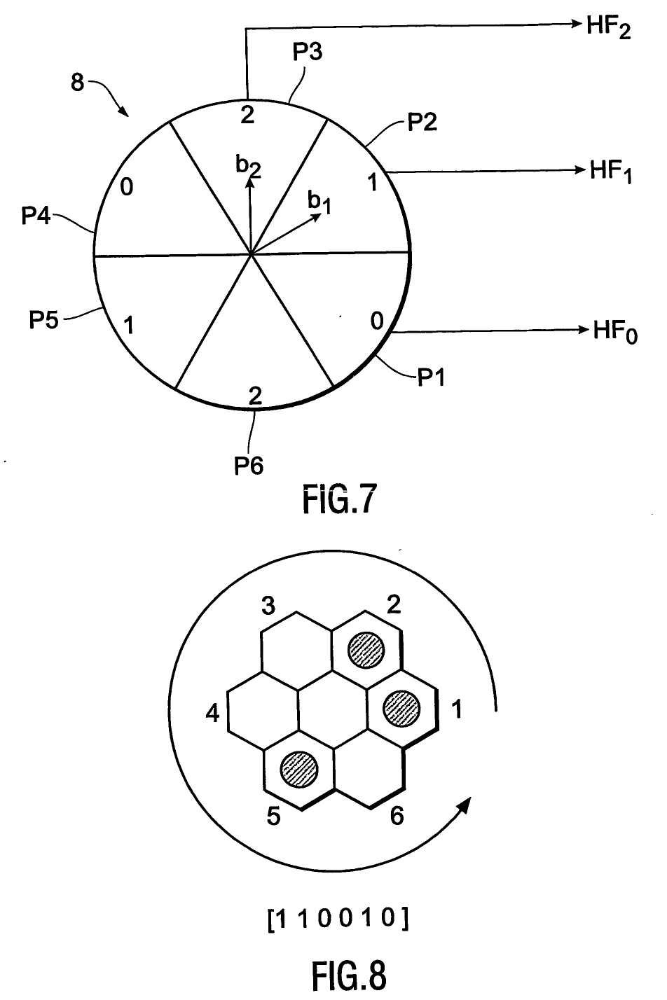

FIG. 7 shows an embodiment of a partitioned photo-detector according to the present invention,

FIG. 8 illustrates the indexing order of nearest neighbour bits in a hexagonal bit cluster,

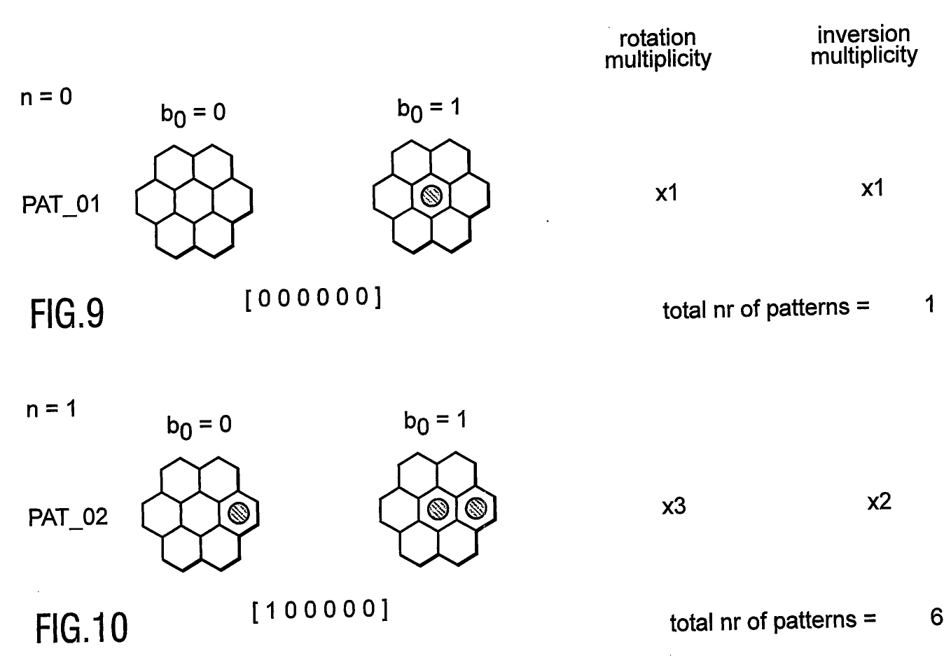

FIGS. 9 to 15 show the cluster types for different numbers of nearest neighbour pit-bits,

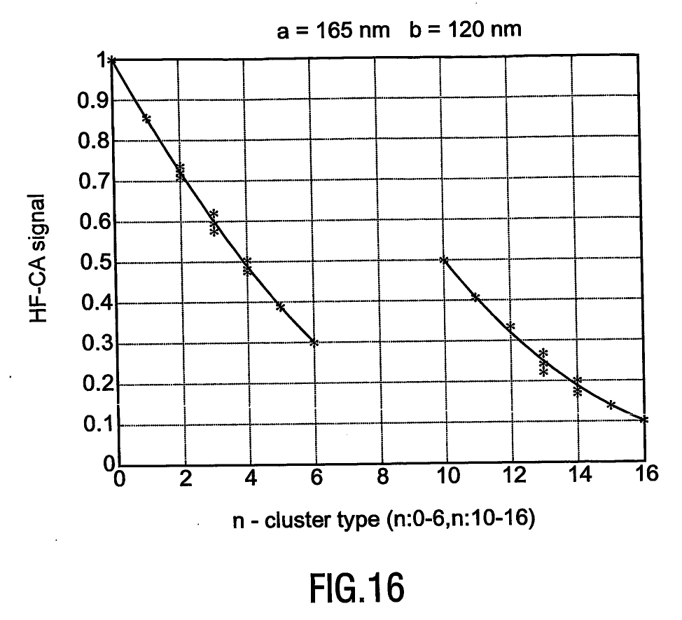

FIG. 16 shows the HF signals for different cluster types,

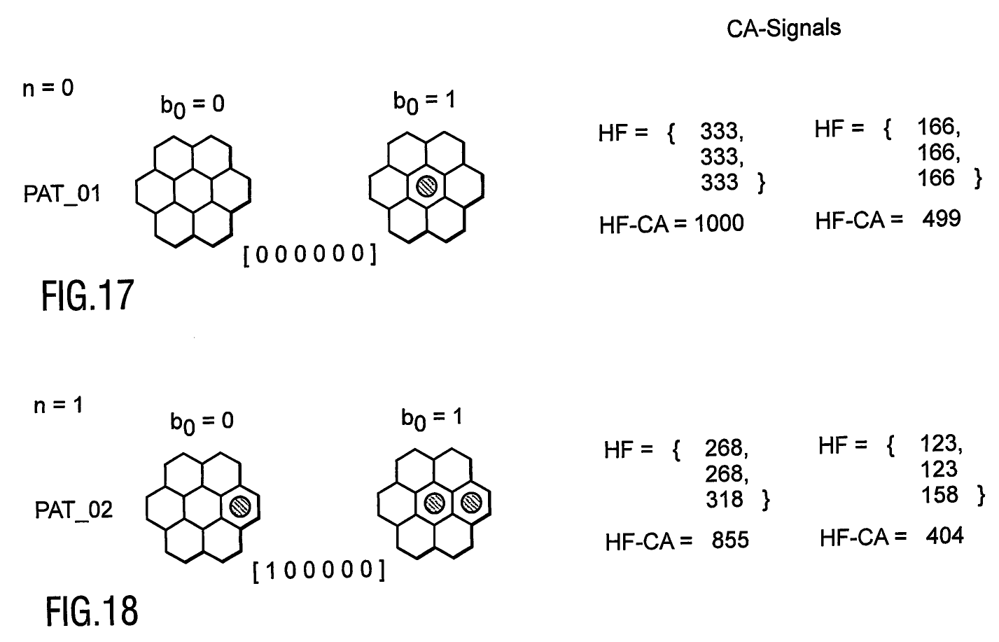

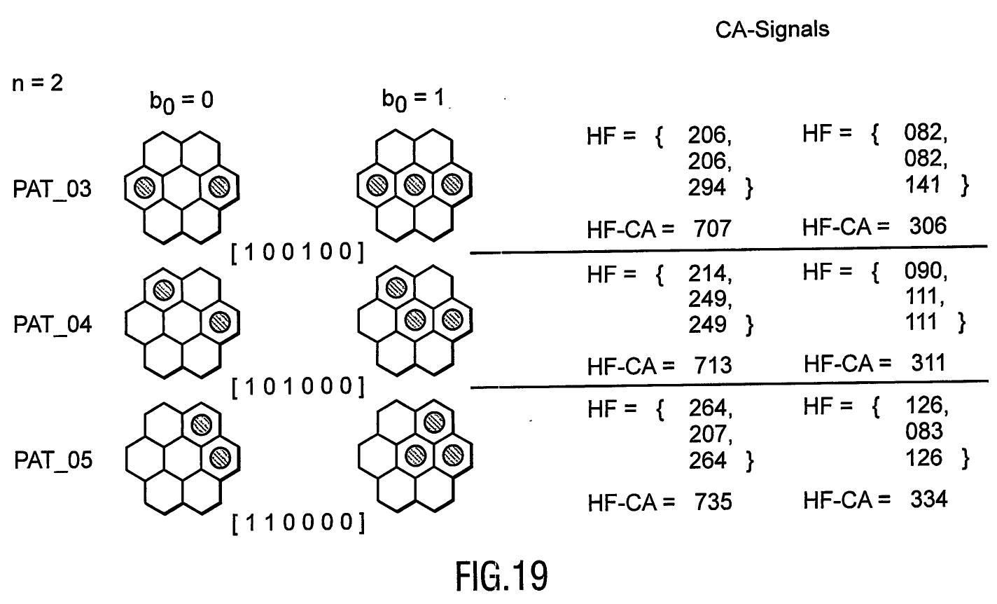

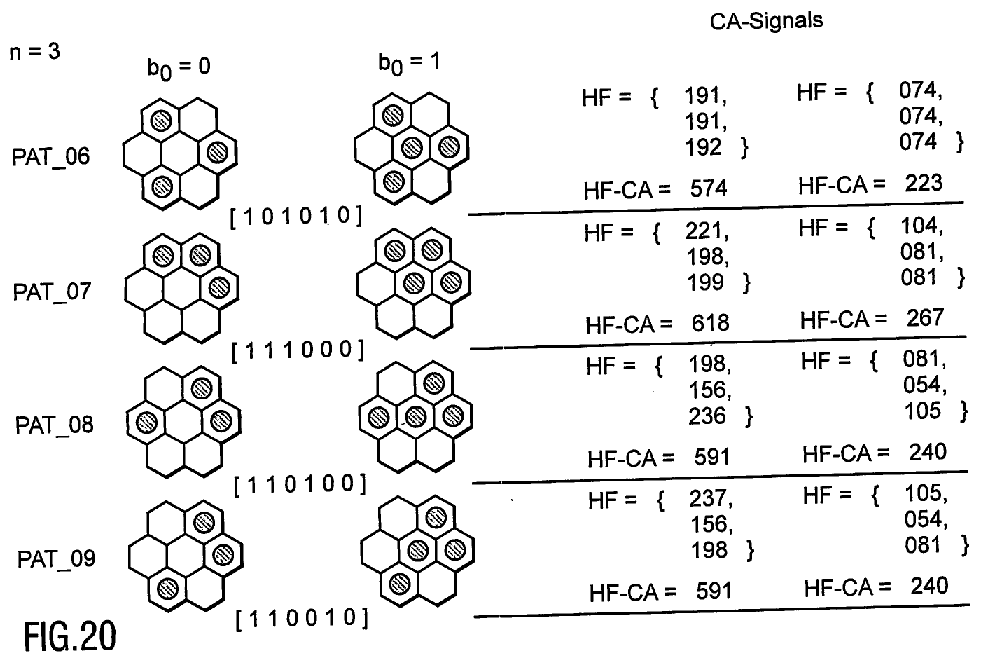

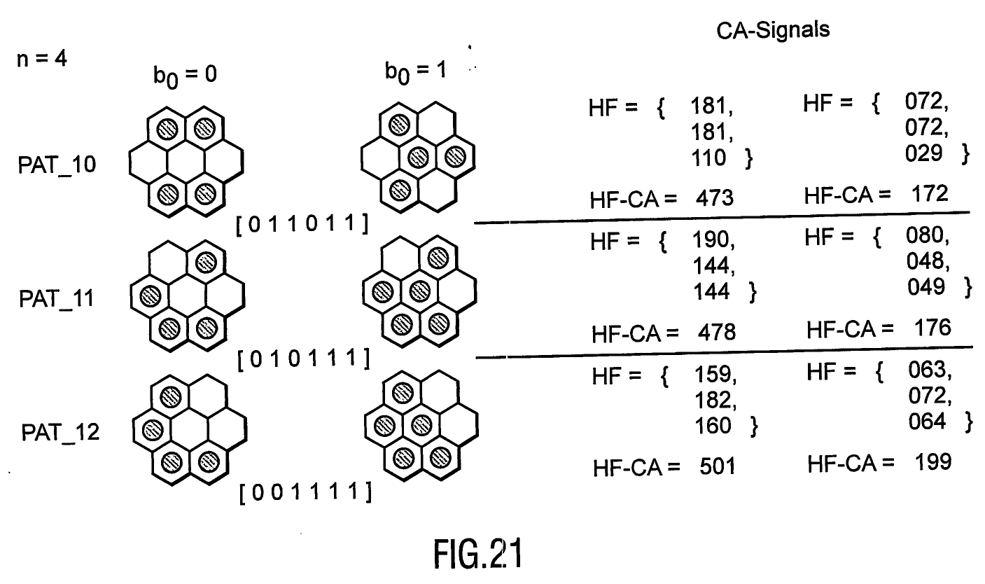

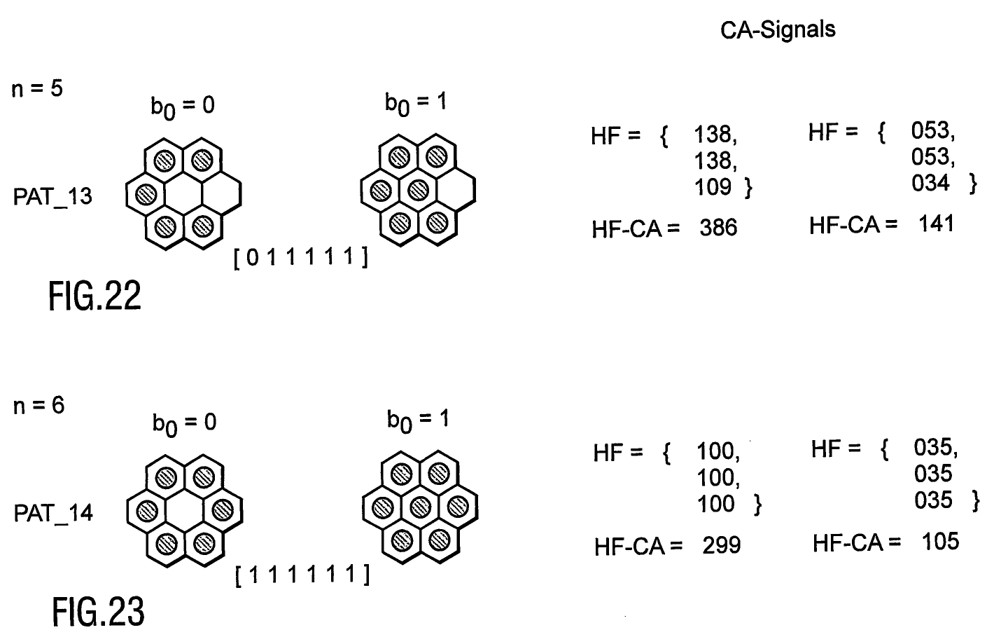

FIGS. 17 to 23 shows the partial HF signals and the HF-CA signals for the different cluster types,

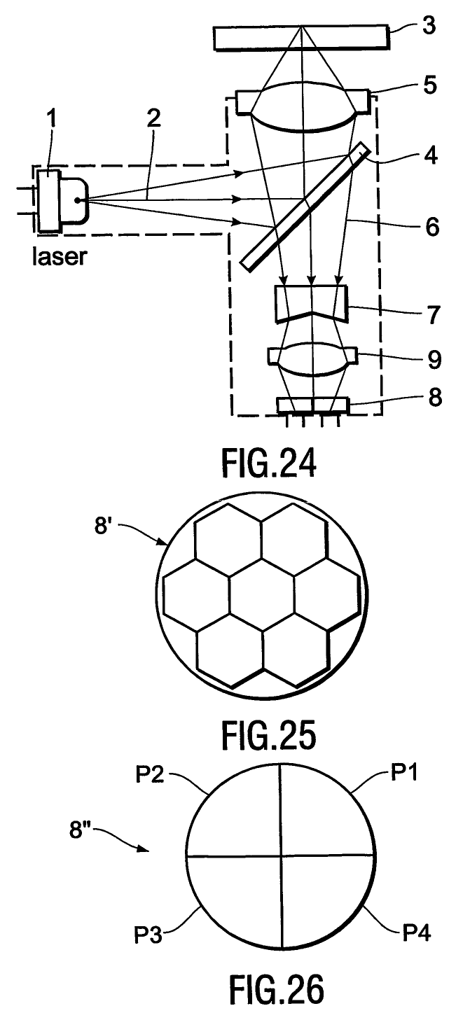

FIG. 24 shows another embodiment of a read-out apparatus according to the present invention,

FIG. 25 shows another embodiment of a photo detector according to the present invention for use in image-plane partitioning,

FIG. 26 shows another embodiment of a photo detector according to the present invention for use with a square-lattice code,

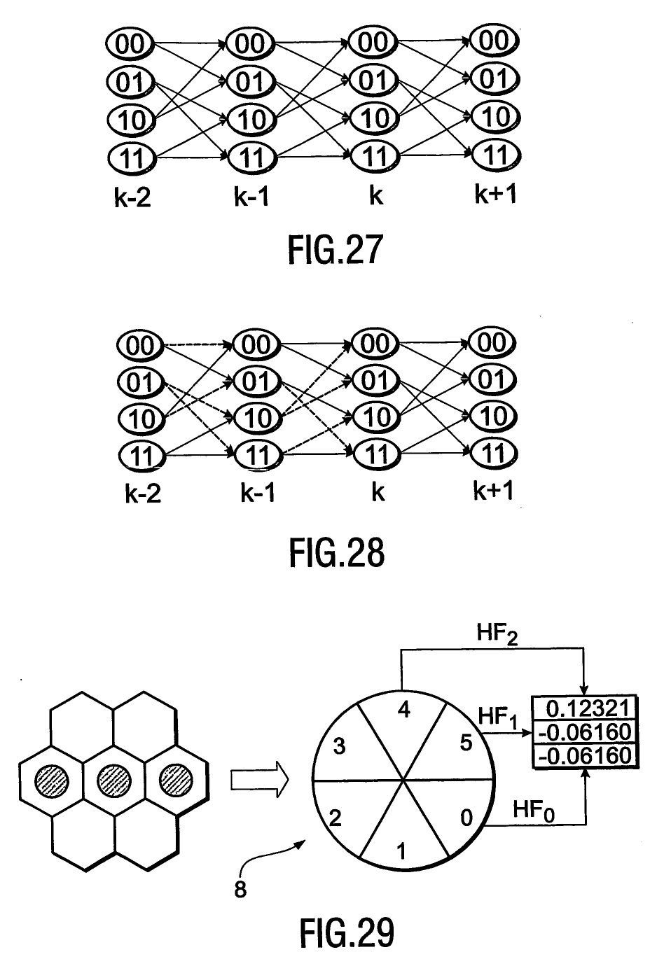

FIG. 27 shows a trellis for 1D Viterbi-detection for binary symbols,

FIG. 28 an example for the convergence of the paths in a trellis,

FIG. 29 shows an example of a symmetric bit arrangement and the resulting partial HF signals with the six-fold partitioned photo detector and

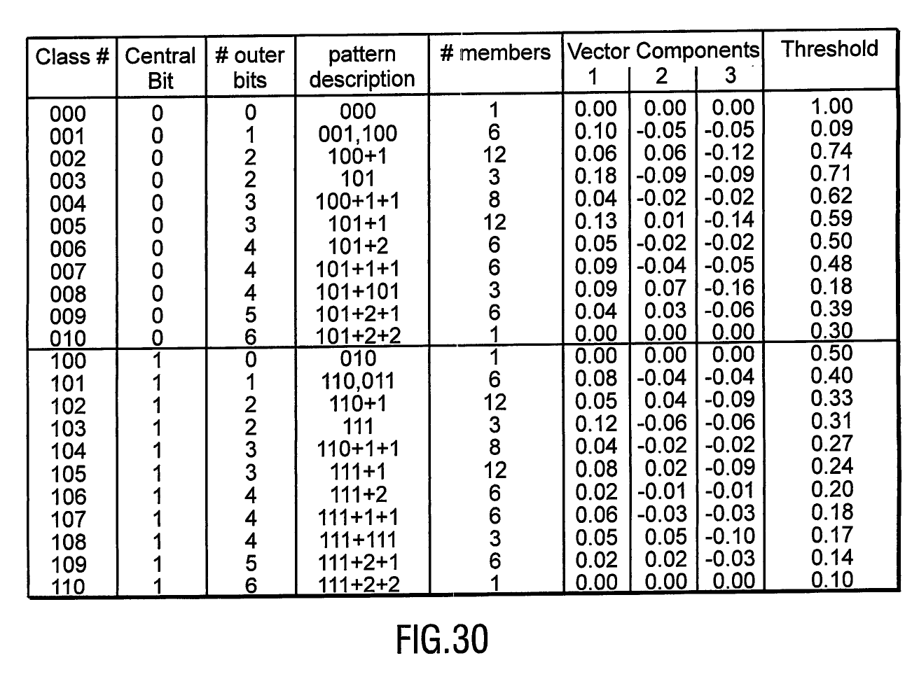

FIG. 30 shows the 22 different pattern classes using symmetry-detection operators in threshold detection.

FIG. 1 shows typical coding and signal processing elements of a data storage system. The cycle of user data from input DI to output DO can include interleaving 10, error-correction-code (ECC) and modulation encoding 20, 30, signal preprocessing 40, data storage on the recording medium 50, signal post-processing 60, binary detection 70, and decoding 80, 90 of the modulation code, and of the interleaved ECC. The ECC encoder 20 adds redundancy to the data in order to provide protection against errors from various noise sources. The ECC-encoded data are then passed on to a modulation encoder 30 which adapts the data to the channel, i.e. it manipulates the data into a form less likely to be corrupted by channel errors and more easily detected at the channel output. The modulated data are then input to a recording device, e.g. a spatial light modulator or the like, and stored in the recording medium 50. On the retrieving side, the reading device which transforms detected light into an electrical signal, e.g. a photo-detector device or charge-coupled device (CCD) returns pseudo-analog data values which must be transformed back into digital data (one bit per pixel for binary modulation schemes). The first step in this process is a post-processing step 60, called equalization, which attempts to undo distortions created in the recording process, still in the pseudo-analog domain. Then the array of pseudo-analog values is converted to an array of binary digital data via a bit detector 70. The array of digital data is then passed first to the modulation decoder 80, which performs the inverse operation to modulation encoding, and then to an ECC decoder 90.

In the classical paradigm of optical storage a single spot of light is used to scan the surface of the storage medium, which is usually a circular disc (with a 12 cm diameter). The information on the medium is stored as bits aligned in one-dimensional tracks, which are spiralling from the inside to the outside of the medium. Depending on the technology the “1”-bits on the disc can be represented by pits in the surface with the depth of (ideally) one-fourth of the wavelength of the light used to read out the data, thus having destructive interference through a total path-difference of half a wavelength. The “0”-bits are represented by the plain surface, also called land. Also the neutral areas between the tracks are coded ‘land’. This representation is used in a read-only system with physically mastered pits (e.g. CD-ROMs). Another representation is to use an optically active material that causes a phase shift to the incident light depending on an inner state of the material. In this case a “1” can be represented by a phase shift of half a wavelength and “0” by no phase shift, depending on the inner state of the material. The same light beam that is used for read out can now be used to change the state of the phase-change material (from crystalline to amorphous); this principle is used to form a read-write system (e.g. CD-RW).

Regardless of the system being used, the light beam 2 generated by a laser diode 1 is directed and focused onto the surface of the medium 3 by a beam splitter 4 and an objective lens 5, and is both reflected and diffracted according to the features representing the bits on the medium 3 as shown in FIG. 2. As the beam spot on the surface is often greater than the distance of the track to its neighbouring tracks, intersymbol interference (ISI) from other bits has to be taken into account. The ISI is the stronger the closer the tracks are together. The outgoing signal 6, the reflected and diffracted light wave fronts, passes back through the objective lens 5 (central aperture), the beam splitter 4 and a wedge 7. The intensity can be measured as a high-frequency (HF) signal by a photo detector 8.

In 2D optical recording, efforts have been made to increase both the maximum storage capacity of the medium as well as the data rate by using several beams to read out the information from the medium simultaneously, leading to a data rate proportional to the number of beams reading out at the same time. The capacity is increased by positioning the bits not in individual tracks with neutral guard-bands between them, regions that carry the bit-information ‘zero’ to reduce ISI and to generate the interference signals, but by arranging the bits in a two-dimensional lattice on the medium, thereby using the existing surface to a much greater extent. With increased data density the influence of the neighbouring bits also increases drastically. Because lattices are translationally invariant, the positions of the neighbouring bits with respect to a central bit are always the same. Consequently, there is a limited set of possible diffraction patterns caused by a limited number of possible combinations of bits in one region on the lattice.

The passing of the light through a lens system is mathematically equivalent to the Fourier transformation of a (complex-valued) wave function, forming a space of reciprocal lattice vectors that correspond to the original lattice vectors in real space. As the Fourier transformation of a vector is orthogonal to itself, the reciprocal vectors would show a similar symmetry as the vectors in real space, only with inverse length. That allows mapping the bit patterns on the storage medium (in real space) to their resulting diffraction patterns in Fourier space, thus enabling bit detection in two dimensions. This gave rise to the idea to use the symmetry of the possible bit-patterns of the clusters to receive additional information about the probable state of the bits on the surface of the storage medium. If the central aperture of the lens were partitioned so that it has the same multiplicity as the original lattice, one would expect that the intensity levels of the HF-signals for each partition would give clues about the cluster patterns from which the signals originated.

In non-prepublished European patent application EP 01203878.2 (=PHNL010746) the 2D constrained coding on hexagonal lattices in terms of nearest-neighbour clusters of channel bits is described. Therein, it has been focussed mainly on the constraints with their advantages in terms of more robust transmission over the channel, but not on the actual construction of such 2D codes. The latter topic is addressed in the non-prepublished European patent application EP 02076665.5 (=PHNL 020368), i.e. the implementation and construction of such a 2D code is described therein. By way of example, a certain 2D hexagonal code shall be illustrated in the following. However, it should be noted that the general idea of the invention and all measures can be applied generally to any 2D code, in particular any 2D hexagonal or square lattice code.

As mentioned, in the following a 2D hexagonal code shall be considered. The bits on the 2D hexagonal lattice can be identified in terms of bit clusters. A hexagonal cluster consists of a bit at a central lattice site, surrounded by six nearest neighbours at the neighbouring lattice sites. The code evolves along a one-dimensional direction. A 2D strip consists of a number of 1D rows, stacked upon each other in a second direction orthogonal to the first direction. The principle of strip-based 2D coding is shown in FIG. 3. Between a number of consecutive strips a guard band of, for instance, one row high may be located.

The signal-levels for 2D recording on hexagonal lattices are identified by a plot of amplitude values for the complete set of all hexagonal clusters possible. Use is further made of the isotropic assumption, that is, the channel impulse response is assumed to be circularly symmetric. This implies that, in order to characterize a 7-bit cluster, it only matters to identify the central bit, and the number of “1”-bits (or “0”-bits) among the nearest-neighbour bits (0, 1, . . . , 6 out of the 6 neighbours can be a “1”-bit). A “0”-bit is a land-bit in our notation. A typical “Signal-Pattern” is shown in FIG. 4. Assuming a broad-spiral consisting of 11 parallel bit rows, with a guard band of 1 (empty) bit row between successive broad spirals, the situation of FIG. 4 corresponds to a density increase with a factor of 1.7 compared to traditional 1D optical recording (as used in e.g. in the Blu-ray Disc (BD) format (using a blue laser diode).

For a more simple analysis of the bit detectors, the channel is often approximated by a fully linear one with a 7-bit impulse response, and with a central tap denoted by c₀, and a nearest-neighbour tap (the same coefficient for all 6 nearest neighbour bits in the cluster) denoted by c₁. The schematic Signal-Pattern for this simplified model, together with that one for the “exact” scalar-diffraction model, is shown in FIG. 5. It applies for a density gain with a net factor of about 1.4 (compared to 1D-BD). FIG. 5 reveals the respective sizes of a user bit for 2D-modulation, and for BD (1D). The factor of 11/12 accounts for the presence of the guard band (of one empty row).

The situation of FIG. 5 corresponds with c₀=4c₁ in the simpified abstracted channel model. It is to be noted that the three bottom signal levels of the clusters with a “0”-bit as central bit, have an overlap with the three top signal levels of the clusters with a “1”-bit as central bit. This overlap in signal levels is the basic problem of the “closed eye” for 2D optical storage at these more ambitious storage densities.

An adapted write-strategy for the ROM write-channel has been proposed, in order to avoid signal folding: in a pit-bit, a small preferably circular pit-hole covering about 50% of the bit-area is to be realized via the write-channel. Assuming the read-channel of BD (λ=405 nm; NA=0.85), the lattice parameter of the hexagonal lattice amounts to 195.2 nm (with a pit-hole with radius b=60 nm for the pit-bits). The signal waveforms in FIG. 5 are not equalized (raw waveform). This situation corresponds with the same user capacity as for the BD system.

In the following a more detailed evaluation for the hexagonal lattice will be made. Hexagonal clusters consisting of 7 bits, one central bit and its six (nearest) neighbour bits will be considered. The bit cells for such a cluster are shown in FIG. 6, together with the coordinate system in real space (FIG. 6a) and in reciprocal space (FIG. 6b), the latter describing the 2D (spatial frequency) space in the exit pupil where the diffraction pattern is formed.

One possible implementation of the invention is a 3-fold partitioning of the photo detector as is shown in FIG. 7: the detector surface of the photo detector is first divided into six pieces of a pie, with the pieces oriented along the direction of the basis vectors b₁, b₂ of the reciprocal lattice. From these six pieces P1-P6, pieces at opposite azimuths to each other are connected, i.e. P1 and P4, P2 and P5, and P3 and P6, yielding thus a 3-fold partitioned photo detector. At each these three partitions a separate HF signal HF₀, HF₁ and HF₂ can be measured. The information distribution in the exit pupil for a non-aberrated spot that is positioned exactly in the center of the hexagonal cluster, has inversion symmetry about the origin in reciprocal space: therefore, the photon counts for opposite parts are just added, because they represent (exactly) identical information.

The basic or independent cluster types (or cluster classes) are now explained: a cluster type or class comprises all clusters that can be transformed one into another by means of rotation over 60, 120, 180, 240 or 300 degrees, or by point inversion (with the center of inversion located in the center of the cluster). It turns out that there are 28 of such independent cluster classes, 14 with the central bit value b₀ equal to 0, and 14 with b₀ equal to 1. These basic cluster classes are denoted in FIGS. 10 to 16 as PAT-01, PAT-02, . . . , PAT-14. In order to describe the different cluster classes, the convention for the indexing of the neighbour bits as shown in FIG. 8.

FIGS. 9 and 10 yield the first two independent cluster patterns for the case where the number of (nearest) neighbours of the pit-type, with bit-value “1”, this number being denoted by n, is set to n=0 and n=1, respectively. For the latter case, there are three rotational variants of this cluster type (over 0, 60 and 120 degrees) that lead to rotated signal distributions in the exit pupil that can be distinguished from each other. Each of these three rotational variants has a related cluster type obtained by applying the point inversion (at the origin) which yields identical signal distributions in the exit pupil. So, this typical cluster has 6 possible variants in total, but distinction can only be made between three pairs, each pair comprising two clusters that are related by the point inversion.

The advantage of detection with the partitioned photo detector can be argumented as follows. The case is addressed with a standard HF signal that is characteristic for a central bit b₀ with one neighbour of the pit-type. From the standard HF signal alone, which is just the sum of the three partial BF signals, it can not be determined in which direction this neighbour pit bit is located. On the other hand, if the three partial HF signals from the partitioned photo detector are available, then it can be derived whether the pit bit is located in the azimuths of 0 or 180 degrees, or in the azimuths of 60 and 240 degrees, or in the azimuths of 120 and 300 degrees: these are the three pairs of distinct cluster pairs that can be distinguished in this cluster class for n=1. Thus, it is clear that this extra information alone is not enough to locate the neighbour bit; however, each neighbour bit in the cluster at hand, for which bit detection is being carried out, is also neighbour bit in five different clusters, and is also the central bit of its “own” cluster: combination of all these separate pieces of information, for instance through a kind of maximum-likelihood procedure, yields an improved bit detection, with larger robustness than bit detection based on the standard HF signals.

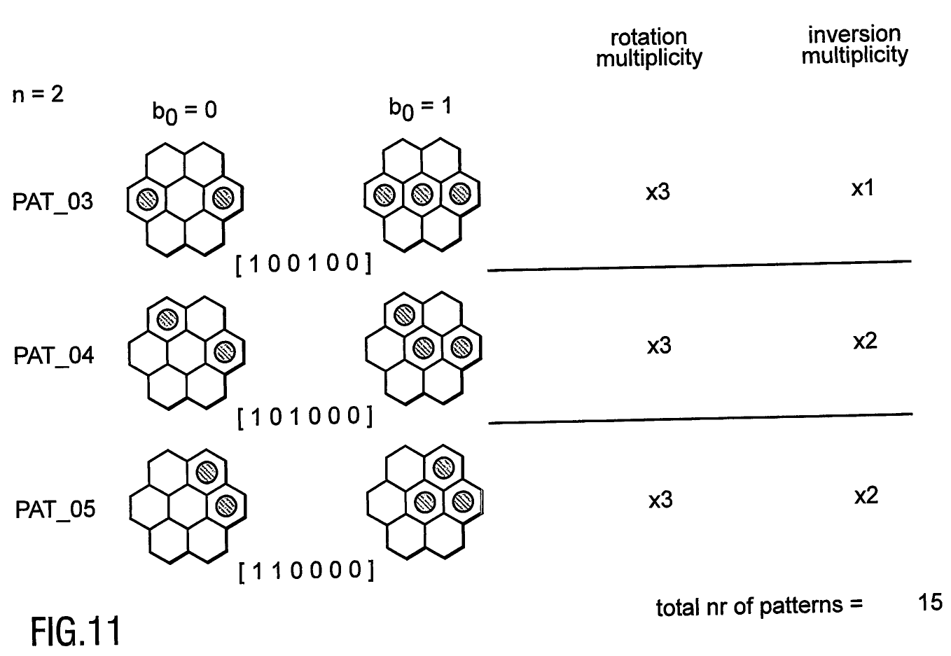

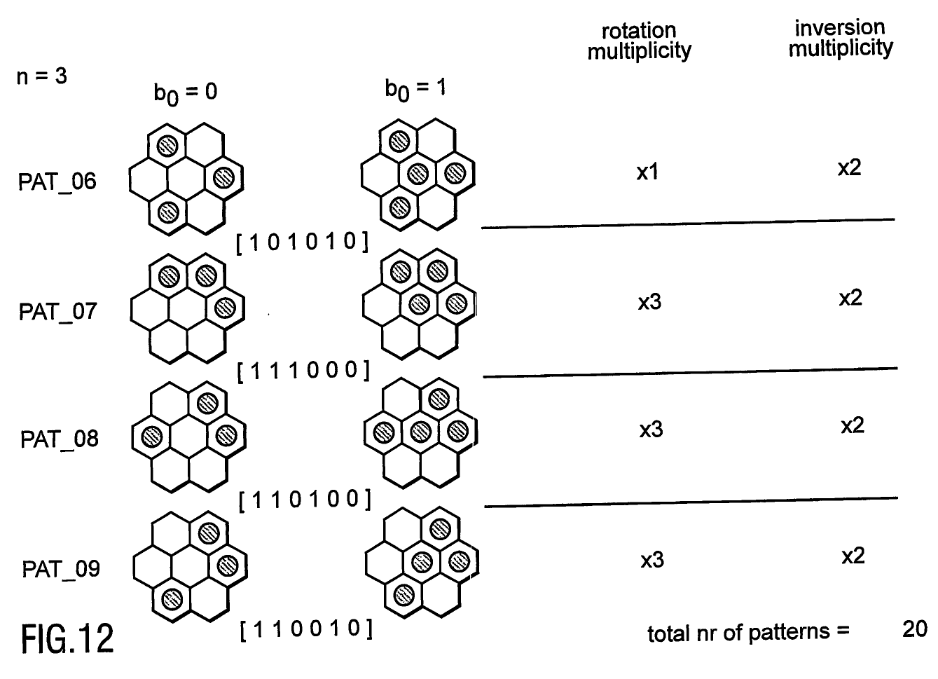

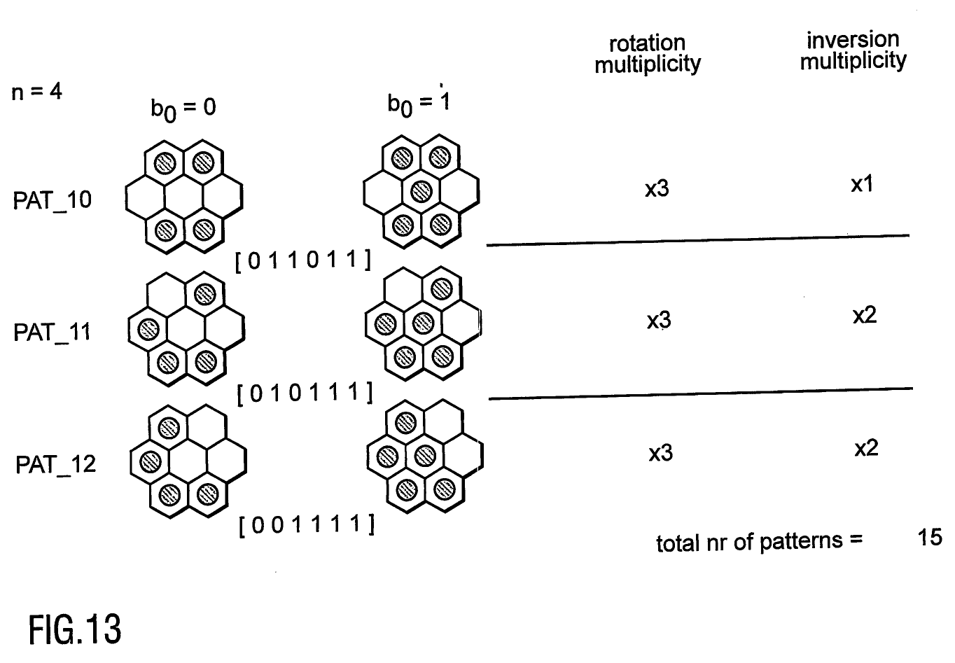

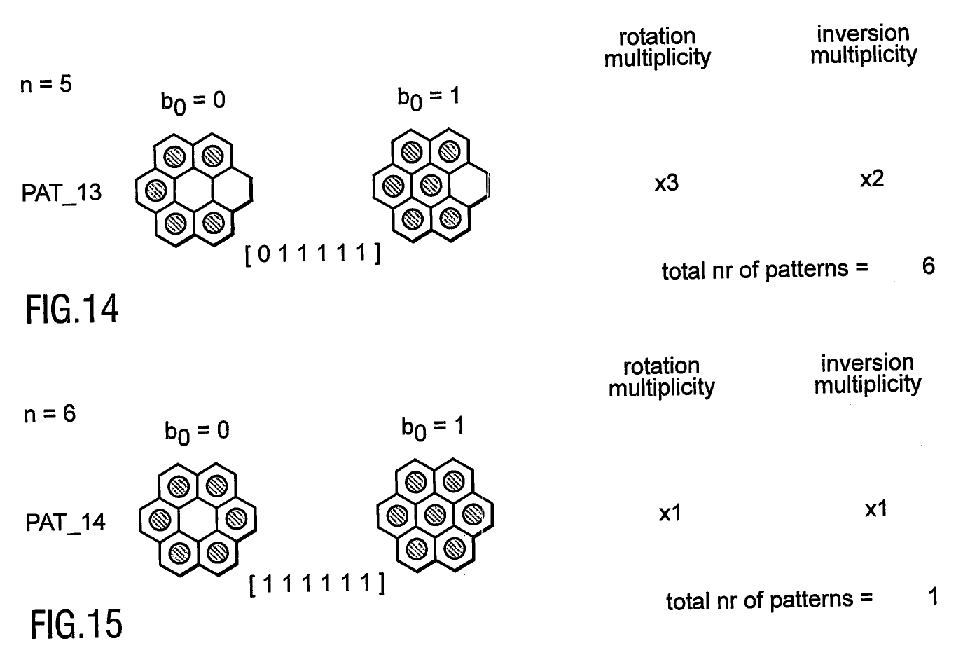

FIG. 11 shows the three independent patterns for the case where the number of (nearest) neighbors of the pit-type equals n=2. There are three independent cluster types (or cluster classes) for this case. In total, there are 15 different clusters. The three clusters that correspond to PAT-03 yield unique signal distributions in the exit pupil because these clusters have inversion symmetry. In such case, detection of the characteristic patterns in the partitioned photo detector makes it possible to decide unambiguously on the position of the two neighbour pit bits along one of the three diagonals of the hexagonal lattice. The remaining 12 clusters are divided over two independent cluster types: for each cluster type, there are three pairs of clusters that have a unique signal distribution in the exit-pupil, with each pair comprising two clusters related to each other through the point inversion. A similar ordering of clusters is done for the cases with the number of (nearest) neighbours of the pit type equal to n=3 (FIG. 12), n=4 (FIG. 13), and n=5 (FIG. 14) and n=6 (FIG. 15).

Partial HF-signals for the three-fold partitioning in the exit pupil have been simulated based on scalar diffraction calculations for blu-ray (BD) optics conditions (lambda=405 nm, NA=0.85). Also the standard HF signal (HF-CA signal), being just the sum of the three partial HF signals with parameters: bit-distance (or hexagonal lattice parameter) a=165 nm, pit-hole diameter for pit bits (with bit value equal to 1) b=120 nm. The phase depth of the pit-holes has been assumed to be π, so that the reflection function of the disc at the pit area equals “−1” (where it equals “1” for the land area). The standard HF signal for various clusters is shown in FIG. 16: the curves represent the average HF signals, the individual “stars” indicate HF signals for the various cluster types (with different arrangements of the same number of neighbour pit bits). The signals are listed in FIGS. 17-23. The differences in the individual HF signal components of the partitioned situation reveal that the different cluster types (together with its rotational variants, but not its inversion variants) can be discriminated so that (partly) information about the position of its neighbour pit bits can be obtained.

Partitioning can also be performed in the image plane where the pit-structures on the disc are directly imaged. The set-up of an appropriate read-out apparatus is shown in FIG. 24. Compared to the read-out apparatus shown in FIG. 2 a properly adjusted optical-light path is used, e.g. adjusted by an additional lens 9 between the beamsplitter 4 and detector 8. Such detection mode does not suffer from the inversion-symmetry ambiguity, so that a 6-fold partitioning with partitions in the directions of the neighbour bits may be advantageous. Such a photo detector 8′ is shown in FIG. 25. The dependency on the aberrations on the return path through the cover layer of the disk, from information layer through lenses 5, 9 towards the image plane on the detector 8′ and on the phase depth of the pits might be different than in case of the diffraction mode considered thus far.

Above, the invention has been described for the symmetric case with a non-aberrated spot. In the case of an aberrated spot, the inversion symmetry in the detector plane may no longer exist. Instead of 3 partitions, 6 partitions of the detector are required. Two strategies can be adopted. A first strategy is to use as reference “fingerprints” fingerprints that are also distorted by the asymmetry in the scanning spot, and to derive the status of the distortion by some other means. Another strategy is to equalize the 6 (asymmetric) signals into 3 symmetric signals via an multi-signal adaptive equalizer (6 signal input, 3 signal output).

Further, the present invention can be combined with other ideas to derive the aberration(s) of the optical spot from the (low-pass filtered) signals that are detected on the partitions of the photo-detector. That result can be of use, for instance, as input for an adaptive equalizer, or for an LCD cell for aberration compensation.

In the above the invention has been described for the case of the hexagonal lattice. However, the invention can also be applied for other 2D lattice types (like the square lattice). For instance, for a square lattice, a photo detector 8″ can be used that is partitioned into four partitions P1 to P4 as shown in FIG. 26. A square lattice does, in general, comprise a central bit and four neighbouring bits (or eight neighbouring bits if the diagonal bits are considered as neighbouring bits as well). In addition, also another number of partitions, for all kinds of lattices, is possible, for instance a 5- or 7-fold partitioning for the hexagonal lattice.

For asynchronous signals, the signal samples are taken at arbitrary phases with respect to the ideal bit positions. In such case (as in the aberrated case above), the signals (intensities) in the diffraction plane will not be inversion-symmetric about the origin. A 6-fold partitioning is therefore a more likely implementation than the 3-fold partitioning in which opposite detector partitions originating from the 6-fold partitioning are added. In such case, a 6-fold partitioning with the 6 partitions as shown in FIG. 7 could be used (without the combination of inversion-related partitions). Moreover, 3 push-pull signals for further signal detection could be obtained, with each of the push-pull signals generated along one of the three main directions of diffraction by subtracting the signals from opposite detector partitions in the 6-fold partitioning. Still further, the combination of the integrated HF-CA signal together with the 3 push-pull signals can be evaluated. Many combinations and possibilities exist.

Each partition in the photo-detector will be subject to its characteristic electronic noise contributions (voltage-noise and current-noise). Moreover, the shot noise of each partition will be larger than for a single detector that receives the total photon contribution. Taking these SNR considerations into account it can be advantageous to limit the number of partitions to the minimum required for realizing a benefit from the partitioning strategy.

The classical case of PRML bit detection is well known in the state of the art for one-dimensional modulation and coding, as for instance described in Chapter 7 “Viterbi Detection” by Jan Bergmans, “Digital Baseband Transmission and Recording”, Kluwer Academic Publishers, 1996. In the bit detector according to the present invention the Viterbi-Detection-Algorithm is used as a maximum-likelihood detection-algorithm in the presence of ISI and noise. The Viterbi-detector works on the principle of dynamic programming much like the shortest path algorithm does. In the shortest path problem the aim is, as the name says, to find the sequence of edges s⊂E between two specified points S and D through a directed graph G=(V,E) for which a cost function c(s) becomes minimal. This sequence of edges, which is called the path through the graph with minimum cost (or the cheapest path), can be found by calculating the costs for all possible paths, which would be exponentially many with increasing number of knots. Alternatively one could begin at the starting knot S, then choose an adjacent knot and determine the minimal distance to that knot by comparing all lengths of all incident edges. The knot is then added to the starting knot to form the set of points on the graph for which the minimal distance is known. This process is repeated for every knot of the graph, finding the minimal distance between the knots and the knots in the set of known points.

At the end of this algorithm, every knot on the graph has minimal distance to the starting knot, and the knots that connect the starting point and knot D are the knots on the shortest path between S and D. The algorithm terminates when all the knots have been explored, or when no more points can be added. If D is not part of the set of explored knots, the graph is partitioned and the algorithm has no solution. As every knot is only handled once, and since every knot can only have maximal n=|E| number of outgoing edges, the complexity of the algorithm is then o(m*n) with m=|V|.

The Viterbi-Detection-Algorithm works in a similar way. It also uses a graph, generally called the trellis diagram. Aim of the algorithm is to perform Maximum-likelihood detection, i.e., determine which signal was most likely the input signal to the noised output signal bₖ. The Maximum-likelihood sequence is basically a path through the trellis. The trellis is made up out of states, which are composed out of all possible transitions between two detected symbols. The length of the path or the number of succeeding states is called the memory length M, because M is also the number of symbols that have to be stored. The number of different symbols that are to be distinguished is L, as it also refers to amplitude levels in signal processing. For example, with binary input, L would be 2, and the number of states in the trellis would thus be L^{M}.

For example, the trellis shown in FIG. 27 has states that are made up out of two succeeding binary levels from a sequence of bits, and a state has two possible transitions to a state in the next time step with which it has the last bit in common. For every transition, also called branch of the trellis, there exists a cost function or branch metric, for example the Euclidean distance in k-space
Pₖ=∥RLₖ−rₖ∥₁²=(RLₖ−rₖ)²
between the noiseless system response RLₖ for the bit bₖ at time step k, called the reference level, and the received output signal rₖ. Just like in the shortest path algorithm the Viterbi detector seeks to find the path through the graph with the minimal total costs
λ=Σₖ₌₀ⁿβₖ=Σₖ₌₀ⁿ(RLₖ−rₖ)²
from the starting state to the present state. The Viterbi algorithm calculates for a given state sₖ all the possible branch metrics back to the set of states sₖ₋₁ and chooses the minimal branch to be part of the path from the current state backwards in the trellis. This stage of the algorithm is called the add-compare-select part as it adds the branch metric of the edges to the error functions of the last set of states, compares them, and then selects the optimum to be part of the path of that state. Because a state can have only one minimal branch backwards, but a state from the set sₖ₋₁ can be the best preceding state for L states, the trellis tends to converge to a common state very quickly as can be seen in FIG. 28. Typically after about 5 L time steps the paths of all the states of the current time step k originate from one common state. A backtracking depth of M=5 L can then be used for Maximum-likelihood bit-detection.

The Viterbi bit detection algorithm can easily be extended to multi-track detection. The multi-track Viterbi algorithm processes t tracks simultaneously to find the data sequence b_{k,j} that minimizes the Euclidean distance
βₖ∥\vec{RL}ₖ−\vec{r}ₖ∥₁²=Σⱼ₌₀^{t-1}(RL_{k,j}−r_{k,j})²

From the point of view of the structure of the trellis, the multi-track Viterbi algorithm is actually equivalent to a single-track Viterbi algorithm with L amplitude levels, with L=2^{t}. A column of t tracks of bits is viewed as one track of symbols of an alphabet with 2^{t} elements. In the case of t tracks and thus L=2^{t} different amplitude levels, there are 2^{2t} states with L=2^{t} branches each at every time step k, because a state signifies the transition of one symbol in the sequence to its successor. Therefore, the computational complexity of a multi-track Viterbi algorithm is linear in data size M, just as the single-track Viterbi algorithm is, but is exponential in terms of the number of tracks. This effect limits the use of a multi-track Viterbi algorithm in 2D bit detection algorithms; as the number of tracks that are simultaneously evaluated, increases, the computational complexity becomes prohibitively large.

So far only the system response of a single channel for each bit in the sequence has been of interest. When using a partitioned photo detector as proposed according to the present invention, the bit patterns in a bit lattice that are rotationally equivalent and thus have the same HF signal r_{k,j}, i.e. the same intensity of light is going through the central aperture, can be distinguished by dividing the signal into one signal r_{k,j}⁽ⁱ⁾ for each partition i of the photo detector (or central aperture) with r_{k,j}=Σᵢr_{k,j}⁽ⁱ⁾. The branch metric then becomes
βₖ=Σᵢ∥\vec{RL}ₖ⁽ⁱ⁾−\vec{r}ₖ⁽ⁱ⁾∥₁²=Σⱼ₋₀^{t-1}Σᵢ(RL_{k,j}⁽ⁱ⁾−r_{k,j}⁽ⁱ⁾)²
The number of states depends (exponentially) on the amount of tracks detected simultaneously, not on the number of channels used in the partitioning strategy (to process the tracks), so that the computational complexity (for the branch metric computation) is only linearly affected by adding multiple channel readouts to the algorithm.

Also the usage of metrics other than the Euclidean (L₁-) norm is generally possible. Some commonly known norms are the mentioned Euclidean norm or L₁-norm ∥\vec{a}−\vec{b}∥₁=\sqrt{Σᵢ(aᵢ−bᵢ)²}, the L₂-norm \vec{a}−\vec{b}∥₂=Σᵢ(aᵢ−bᵢ)², or the Maximum-norm

$${‖ {a}^{->} - {b}^{->} ‖}_{max} = {max}_{i} \{ \vert {a}_{i} - {b}_{i} \vert \} .$$

A norm that enhances signals of patterns that are symmetric along one of the axis is also applicable by using operators much like the ones for detecting contrasts, etc. in image processing. These operators transform the original channels into a new set of channels, with their signals being linear combinations of the signals of the former original channels. For example, if it is desired to see if a certain bit pattern was symmetric in the tangential direction (along the tracks), having a partitioned central aperture as shown in FIG. 7, the signals from partitions P1, P3, P5 and P6 are subtracted from the signals of partitions P2 and P5 multiplied by two for normalization. This could be done for the other symmetry axis as well. Adding and subtracting the signals of the partitions also creates a noiseless signal in the presence of mere media or correlated noise, because only the difference between the signals is taken into consideration and in the case of media noise, all signals would have (almost) the same noise.

Next, the symmetry-detection operators shall be explained in more detail. Operators are common in image processing where they are used to detect contrast in brightness, edges, structures, etc. Operators are vectors or arrays of numbers that moved over the arrays that represent the pixels of a picture. For example, a three-column vector (−1 2−1) could be iteratively multiplied to the cells of a (m×n)-matrix to produce a (m×n−2)-matrix that contains vertical edge information.

Similarly a biased multiplication can be used to transform the signal vector into another vector that gives information about the degree of alignment of a seven-bit cluster pattern in one of the three main axes of symmetry. In the present case such a transformation is done by multiplying the signals of the partitions that are on the symmetry axis by +2 and the signals of the ones that don't by −1. A symmetry detection operator for the axis parallel to the tangential direction on the spiral, which corresponds to the signals of the first and fourth partitions, provided a six-fold partitioning strategy is used, is the computed as follows:
HF_(k)=−HF₁(k)+2·HF₂(k)−HF₃(k)−HF₄(k)+2·HF₅ (k)−HF₆(k)
The signals for the other two symmetry axes are computed the same way, only with the signs shifted cyclically. This produces a three-column vector of signals, one signal for every direction of symmetry. The more the pattern aligns to an axis of symmetry, the higher the signal of the corresponding vector element. FIG. 29 gives an example for a symmetric pattern and its operator response. It has been shown that all possible patterns can be distinguished by the arrangement and amplitude of the three-column output-vector of these symmetry detection operators, with the exception of patterns that are inversion-symmetric, of course, which symmetry cannot be detected at all under no-tilt-conditions with partitioning in the frequency plane.

It should be noted that the sum of the three vector-components always equals zero. Also the transformation only considers the difference between the HF signals of the partitions; the correlated noise is thereby effectively taken out of the resulting signal vector.

The signals of the symmetry detection operators can be used in various ways to reassemble the bit-patterns out of the given HF signals. Two ways are briefly introduced here, an adaptation for the Viterbi-detector and a modified threshold-detector. The computation of the output vector is a simple linear transformation that could easily be implemented in hardware, making it in principle a good foundation for a sub-optimal detection algorithm.

The symmetry detection operators can be used in a Viterbi detection algorithm by simply producing the reference levels for the output vector for all possible bit patterns and then talking some metric to compute the deviation of the output vector of the partitions' noised HF signals from the reference levels. In the ideal case the deviation should be close to zero for the correct bit pattern (or its inversion symmetric pattern), because the correlated noise has been taken out of the signals and the output vector would be almost identical to the reference level.

The complexity of the symmetry operator Viterbi detector is the same as for the multi-track Viterbi-detectors already investigated, linear in length of the spiral, but exponential in width.

Threshold detection offers another approach to bit detection via symmetry detection operators. A normal threshold detector can be built out of a partitioned central aperture by adding up the signals of all the partitions. For a threshold detector that uses the symmetry features inherent in the signals of the partitions the threshold levels and the results can be computed separately for each of the three directions of symmetry, and then some way can be devised to find the most probable result from those three suggestions. This could involve soft-decision techniques.

Another way to use the symmetry information is to use the operators only when they are really needed to discern between the bit patterns that have their signals in the error zone around the threshold level (see FIG. 4). The patterns outside this zone produce unambiguous signals anyway, that can be perfectly detected by a common threshold detector; only the ambiguous patterns need the additional information provided by the symmetry of the patterns.

The output vector of a pattern that has three bits in a certain symmetry direction differs significantly from the output vector of a pattern that only has two bits in that direction. It also differs according to the number of bits in off-axis positions. All possible patterns of a seven-bit cluster can thereby be divided into 22 groups or classes, similar to the ones shown in FIGS. 10-15. These classes can be separated by the sign and by the intensity of their output-vector components. In this way it is possible to unambiguously divide the patterns that have ‘0’ as their central bits from those that have a ‘1’. FIG. 30 shows the output vectors for the 22 pattern classes, along with the corresponding threshold levels set-up for a typical lattice parameter of the hexagonal 2D lattice of bits having a lattice vector of a=165 nm and a pit-bit area of half a primary unit cell. The components and the threshold are ordered by amplitude. The notation for the pattern description is as follows: the first three digits denote the bit assignment on the symmetry axis, the single digits describe the off-axis positions. A ‘1’ means there is one off-axis position filled with a bit, the exact position is unknown; a ‘2’ means that two positions on the same side of the axis are filled, as opposed to ‘1+1’ which means that the positions are situated on opposite sides.

By the present invention, in particular including the main feature of using a partitioned photo detector, a considerably improvement of the bit detection performance for 2D optical storage can be obtained.

1. Bit detector for detecting the bit values of bits of a channel data stream stored on a record carrier, wherein the channel data stream comprises a channel strip of at least two bit rows one-dimensionally evolving along a first direction and aligned with each other along a second direction, said two directions constituting a two-dimensional lattice of bit positions, said bit detector comprising:
a photo detector for detecting light reflected from or transmitted through said record carrier in response to one or more incident light beams, each light beam being directed onto a position along said second direction, said photo detector being partitioned into at least two detector partitions for detecting part of the reflected or transmitted light and for generating partial HF signal values, and
a signal processing means for determining the bit values of the bits of said channel data stream from said partial HF signal values.

2. Bit detector as claimed in claim 1, wherein said photo detector is adapted to image the plane of an exit pupil of a lens onto said photo detector, said lens having an exit pupil being provided in an optical read-out unit for directing the light reflected from or transmitted through said record carrier onto said photo detector.

3. Bit detector as claimed in claim 1, wherein the bits of said channel data stream are arranged on a two-dimensional hexagonal or square lattice.

4. Bit detector as claimed in claim 2, wherein the detector partitions are oriented along the directions of the reciprocal space lattice corresponding to the real space lattice of bits.

5. Bit detector as claimed in claim 3, wherein said photo detector is partitioned into an even number of equally sized detector partitions, in particular into four equally sized detector partitions, in case of a square lattice, or into six equally sized detector partitions, in case of a hexagonal lattice.

6. Bit detector as claimed in claim 5, wherein said detector partitions are coupled into pairs of two detector partitions located on opposite sides of said photo detector, each pair of detector partitions being adapted to generate one partial HF signal value from the light detected by the detector partitions of the pair.

7. Bit detector as claimed in claim 5, wherein said signal processing means are adapted for generating a set of push-pull signals by subtracting partial HF signal values generated by detector partitions located on opposite sides of said photo detector.

8. Bit detector as claimed in claim 1, wherein said photo detector is adapted to image the plane of an information layer on said record carrier onto said photo detector.

9. Bit detector as claimed in claim 3, wherein said photo detector is partitioned, in case of a hexagonal lattice, into a number of hexagonally shaped detector partitions, in particular into a cluster of seven hexagonally shaped detector partitions having one central and six surrounding detector partitions.

10. Bit detector as claimed in claim 1, wherein said signal processing means are adapted for determining the bit value of a bit of said channel data stream from partial HF signal values generated by said photo detector from light detected in response to a light beam directed on the bit whose bit value shall be detected and at least one light beam directed on a neighbouring bit of said bit.

11. Bit detector as claimed in claim 3, wherein the bits of said channel data stream are grouped into hexagonal lattice clusters having one central bit and six nearest neighbour bits or square lattice clusters having one central bit and four or eight nearest neighbour bits and wherein said signal processing means are adapted for determining the bit value of a bit of said channel data stream from said partial HF signal values and the sum of said partial HF signal values generated in response to the same incident light beam.

12. Bit detector as claimed in claim 1, comprising a number of said photo detectors each having at least two detector partitions for each bit row.

13. Bit detector as claimed in claim 1, wherein the partial HF signal values, that are generated from the detector partitions for each row, are transformed into another set of modified partial HF signal values that are further used in the signal processing for bit detection.

14. Bit detector as claimed in claim 13, wherein said modified partial HF signal values are generated by means of symmetry operations.

15. Bit detection method for detecting the bit values of bits of a channel data stream stored on a record carrier, wherein the channel data stream comprises a channel strip of at least two bit rows one-dimensionally evolving along a first direction and aligned with each other along a second direction, said two directions constituting a two-dimensional lattice of bit positions, said bit detector comprising the steps of:
detecting light reflected from or transmitted through said record carrier in response to one or more incident light beams, each light beam being directed onto a position along said second direction, by a photo detector which is partitioned into at least two detector partitions for detecting part of the reflected or transmitted light,
generating partial HF signal values by said detector partitions from the detected part of said light, and
determining the bit values of the bits of said channel data stream from said partial HF signal values.

16. Photo detector for use in a bit detector for detecting the bit values of bits of a channel data stream stored on a record carrier, wherein the channel data stream comprises a channel strip of at least two bit rows one-dimensionally evolving along a first direction and aligned with each other along a second direction, said two directions constituting a two-dimensional lattice of bit positions, said photo detector being adapted for detecting light reflected from or transmitted through said record carrier in response to one or more incident light beams, each light beam being directed onto a position along said second direction, and being partitioned into at least two detector partitions for detecting part of said light and for generating partial HF signal values.

17. Reproduction device for reproduction of a user data stream, which is error correction code encoded and modulation code encoded into a channel data stream and stored on a record carrier, comprising a bit detector as claimed in claim 1 for detecting the bit values of bits of said channel data stream and a modulation code decoder and an error correction code decoder.

18. Method of reproduction of a user data stream, which is error correction code encoded and modulation code encoded into a channel data stream and stored on a record carrier, comprising a bit detection method as claimed in claim 15 for detecting the bit values of bits of said channel data stream and a modulation code decoding method and an error correction code decoding method.

19. Computer program comprising program code means for causing a computer to perform the steps of the methods as claimed in claim 15 when said computer program is executed on a computer.
